(19) United States
(12) Patent Application Publication
(10) Pub. No.: US 2023/0081063 A1
(43) Pub. Date: Mar. 16, 2023

(54) ARITHMETIC PROCESSING DEVICE, ARITHMETIC PROCESSING METHOD, AND STORAGE MEDIUM

(71) Applicant: FUJITSU LIMITED, Kawasaki-shi (JP)

(72) Inventor: Shigeyuki Takano, Ichikawa (JP)

(73) Assignee: FUJITSU LIMITED, Kawasaki-shi (JP)

(21) Appl. No.: 17/832,734

(22) Filed: Jun. 6, 2022

(30) Foreign Application Priority Data
Sep. 14, 2021 (JP) 2021-149133

(51) Int. Cl. G06F 7/544

(52) U.S. Cl. CPC G06F 7/5443

(57) ABSTRACT

An arithmetic processing device includes one or more processors configured to compare a sign of first data and a sign of second data for each of data pairs of the first data and the second data, control writing and reading of the data pairs to a first and second buffer, the first buffer preferentially holding a first data pair whose signs match than a second data pair whose signs do not match, execute a multiply-accumulate operation of data pairs sequentially output from the first buffer and data pairs sequentially output from the second buffer in parallel, add operation results, and set an output value to 0 in a case where the number of the first data pairs is smaller than the number of the second data pairs, and a result of the addition when the multiply-accumulate operation of the first data pair is completed is 0 or less.

### CROSS-REFERENCE TO RELATED APPLICATION

This application is based upon and claims the benefit of priority of the prior Japanese Patent Application No. 2021-149133, filed on Sep. 14, 2021, the entire contents of which are incorporated herein by reference.

### FIELD

The embodiments discussed herein are related to an arithmetic processing device, an arithmetic processing method, and a storage medium.

### BACKGROUND

In a neural network calculation method that transforms a cumulative sum value of products of data and weights with a sigmoid function, a method of setting an initial value to non-zero and terminating the cumulative sum when the cumulative sum value of only positive values or only negative values reaches a predetermined value is known.

In a method of calculating a neuron layer of a multi-layer perceptron model, a method of forming an activation function by zero-point mirroring in a negative definition range of an exponential function, multiplying a result of the exponential function, and then performing summing by a step function is known.

Japanese Laid-open Patent Publication No. 10-187648 and U.S. Patent Application Publication No. 2019-0205734 are disclosed as related art.

### SUMMARY

According to an aspect of the embodiments, an arithmetic processing device includes one or more processors configured to compare a sign of first data and a sign of second data for each of data pairs of the first data and the second data, control writing and reading of the data pairs to a first buffer and a second buffer, the first buffer preferentially holding a first data pair whose signs match than a second data pair whose signs do not match, the second buffer preferentially holding the second data pair than the first data pair, execute a multiply-accumulate operation of data pairs sequentially output from the first buffer and data pairs sequentially output from the second buffer in parallel, add an operation result of the multiplier-accumulate operation of the data pairs output from the first buffer and an operation result of the multiplier-accumulate operation of the data pairs output from the second buffer, and set an output value to 0 in a case where the number of the first data pairs held in the first buffer and the second buffer is smaller than the number of the second data pairs held in the first buffer and the second buffer, and a result of the addition when the multiply-accumulate operation of the first data pair is completed is 0 or less.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a block diagram illustrating an example of an arithmetic processing device according to an embodiment;

FIG. 2 is an explanatory diagrams illustrating an outline of an operation of the arithmetic processing device of FIG. 1;

FIG. 3 is a block diagram illustrating an example of a buffer unit of FIG. 1;

FIG. 4 is an explanatory diagram illustrating an example of an input operation of the buffer unit of FIG. 1;

FIG. 5 is an explanatory diagram illustrating another example of the input operation of the buffer unit of FIG. 1;

FIG. 6 is a flowchart illustrating an example of the input operation of the buffer unit of FIG. 1;

FIG. 7 is a flowchart illustrating an example of the operation in steps S18 and S20 of FIG. 6;

FIG. 8 is an explanatory diagram illustrating an example of an output operation of the buffer unit of FIG. 1;

FIG. 9 is an explanatory diagram illustrating another example of the output operation of the buffer unit of FIG. 1; and

FIG. 10 is a flowchart illustrating an example of the output operation of the buffer unit of FIG. 1.

### DESCRIPTION OF EMBODIMENTS

For example, an activation function rectified linear unit (ReLU) used in layer calculation processing of deep learning inputs a cumulative value of a multiply-accumulate operation of data and weights of a plurality of pairs, and outputs “0” in a case where an input value is “0” or less and outputs the input value in a case where the input value is larger than “0”. In a case where it is found that the cumulative value of the multiply-accumulate operation will be “0” or less during the multiply-accumulate operation, an output of the activation function ReLU can be set to “0” without executing the remaining multiply-accumulate operation. Furthermore, since the multiply-accumulate operation takes more operation time than an addition operation or the like, the larger the number of pairs of data and weight, the longer the time needed for the layer calculation processing, for example.

In one aspect, an object of the present embodiments is to shorten a time needed for layer calculation processing using an activation function ReLU in deep learning.

It is possible to shorten the time needed for layer calculation processing using an activation function ReLU in deep learning.

Hereinafter, embodiments will be described with reference to the drawings.

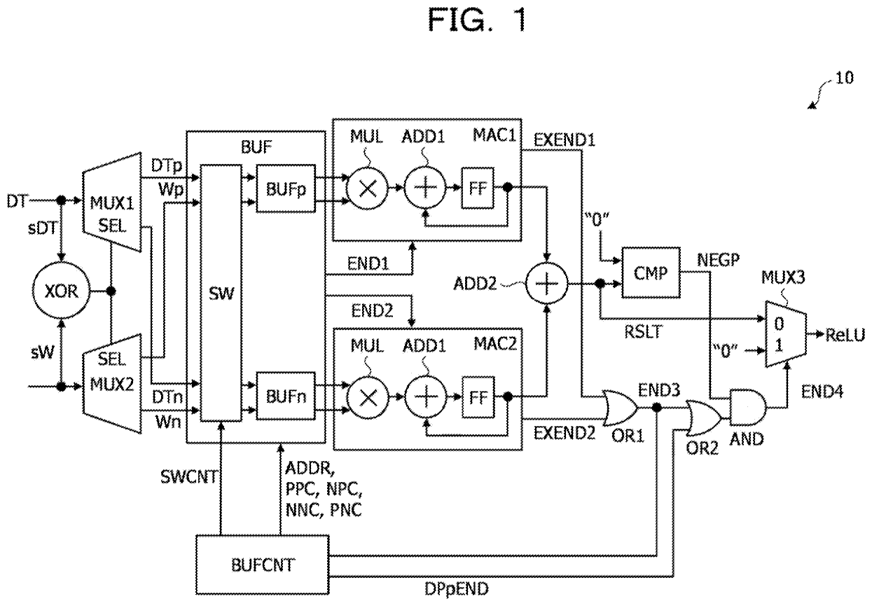

FIG. 1 illustrates an example of an arithmetic processing device according to an embodiment. An arithmetic processing device 10 illustrated in FIG. 1 includes an exclusive OR circuit XOR, multiplexers MUX1, MUX2, and MUX3, a buffer unit BUF, and a buffer control unit BUFCNT. Furthermore, the arithmetic processing device 10 includes multiplier-accumulators MAC1 and MAC2, an adder ADD2, a comparator CMP, OR circuits OR1 and OR2, and an AND circuit AND.

For example, the arithmetic processing device 10 is a processor optimized for a central processing unit (CPU), a graphics processing unit (GPU), or deep learning, and can execute calculation processing for a layer using an activation function ReLU in the deep learning. FIG. 1 illustrates, for example, a circuit that executes calculation processing for each layer of a deep neural network in inference for deep learning. In addition to the elements illustrated in FIG. 1, the arithmetic processing device 10 may include a memory, various arithmetic units, a communication interface, and the like. Hereinafter, an example in which the arithmetic processing device 10 executes processing of accumulating a product of data DT and a weight W input to a layer and acquiring an output value of the activation function ReLU according to a cumulative result. The data DT is an example of first data, and the weight W is an example of second data.

The exclusive OR circuit XOR compares signs by calculating an exclusive OR of a sign bit sDT of the data DT and a sign bit sW of the weight W, and outputs a comparison result to selection terminals SEL of the multiplexers MUX1 and MUX2. The exclusive OR circuit XOR outputs “0” in a case where the signs of the data DT and the weight W match, and outputs “1” in a case where the signs of the data DT and the weight W do not match. The data DT and the weight W having the signs that match are a data pair having a multiplication result that is a positive value. The data DT and the weight W having the signs that do not match are a data pair having a multiplication result that is a negative value. The exclusive OR circuit XOR is an example of a sign comparison unit that compares the signs of the data DT and the weight W.

The multiplexer MUX1 outputs the data DT as data DTp when receiving “0” at the selection terminal SEL, and outputs the data DT as data DTn when receiving “1” at the selection terminal SEL. The multiplexer MUX2 outputs the weight W as a weight Wp when receiving “0” at the selection terminal SEL, and outputs the weight W as a weight Wn when receiving “1” at the selection terminal SEL.

The buffer unit BUF includes a switch unit SW and buffers BUFp and BUFn. The buffer BUFp holds the data pair of data DTp and weight Wp in preference to the data pair of data DTn and weight Wn. The buffer BUFn holds the data pair of data DTn and weight Wn in preference to the data DTp and weight Wp. The buffer BUFp is an example of a first buffer, and the buffer BUFn is an example of a second buffer. Hereinafter, the weights Wp and Wn are also referred to as data Wp and Wn.

The switch unit SW switches an output destination of the data pair DTp and Wp output from the multiplexer MUX1 from the buffer BUFp to the buffer BUFn on the basis of a switch control signal SWCNT. Furthermore, the switch unit SW switches the output destination of the data pair DTn and Wn output from the multiplexer MUX2 from the buffer BUFn to the buffer BUFp on the basis of the switch control signal SWCNT. The data pair DTp and Wp is an example of a first data pair, and the data pair DTn and Wn is an example of a second data pair.

For example, the buffers BUFp and BUFn each has a buffer size that holds half of a plurality of data pairs used to obtain the activation function ReLU in one layer processing. Note that the buffer size may be changed for each layer type. The buffer unit BUF outputs a counter value CNT received from the buffer control unit BUFCNT to the multiplier-accumulators MAC1 and MAC2.

Furthermore, in a case where all the data pairs to be used for the multiply-accumulate operation are output from the buffer BUFp, the buffer unit BUF outputs a completion signal END1 to the multiplier-accumulator MAC1. In a case of outputting all the data pairs to be used for the multiply-accumulate operation from the buffer BUFn, the buffer unit BUF outputs a completion signal END2 to the multiplier-accumulator MAC2.

The buffer control unit BUFCNT controls writing of the data pair to the buffers BUFp and BUFn (input operation) and reading of the data pair from the buffer BUFp and BUFn (output operation). The buffer control unit BUFCNT generates an address value ADDR and pointer values PPC, NPC, NNC, and PNC for controlling the input operation of the data pair to each of the buffers BUFp and BUFn and the output operation of the data pair from each of the buffers BUFp and BUFn. Furthermore, the buffer control unit BUFCNT generates the switch control signal SWCNT. The buffer control unit BUFCNT starts the input operation of the next data pair for the buffer size to the buffers BUFp and BUFn on the basis of reception of an active level completion signal END3.

In FIG. 1, the buffer control unit BUFCNT outputs the address value ADDR and the pointer values PPC, NPC, NNC, and PNC to the buffer unit BUF. However, the buffer control unit BUFCNT may output a signal for controlling reading and writing of the buffers BUFp and BUFn to the buffer unit BUF instead of the address value ADDR and the pointer values PPC, NPC, NNC, and PNC.

The multiplier-accumulators MAC1 and MAC2 are the same circuit as each other and have a multiplier MUL, an adder ADD1, and a flip-flop FF. Each of the multiplier-accumulators MAC1 and MAC2 multiplies the data pair supplied from the buffer unit BUF, and sequentially adds the multiplication result to calculate the cumulative value. The multiplier-accumulator MAC1 is an example of a first multiplier-accumulator, and the multiplier-accumulator MAC2 is an example of a second multiplier-accumulator.

In the case of receiving the completion signal END1 from the buffer unit BUF, the multiplier-accumulator MAC1 sets an operation completion signal EXEND1 to an active level (for example, “1”) on the basis of completion of a multiply-accumulate operation being executed. In the case of receiving the completion signal END2 from the buffer unit BUF, the multiplier-accumulator MAC2 sets an operation completion signal EXEND2 to the active level (for example, “1”) on the basis of completion of the multiply-accumulate operation being executed.

The adder ADD2 adds the cumulative values that are operation results output by the multiplier-accumulators MAC1 and MAC2, respectively, and outputs an addition result RSLT to the comparator CMP and the multiplexer MUX3. The comparator CMP sets a negative signal NEGP to the active level (for example, “1”) in a case where the addition result RSLT is “0” or less. The comparator CMP sets the negative signal NEGP to an inactive level (for example, “0”) in a case where the addition result RSLT is larger than “0”.

The OR circuit OR1 outputs an OR logic of the operation completion signals EXEND1 and EXEND2 to the OR circuit OR2 and the buffer control unit BUFCNT as the completion signal END3. As described above, the buffer control unit BUFCNT starts the input operation of the next data pair for the buffer size to the buffers BUFp and BUFn in the case of receiving the active level (for example, “1”) completion signal END3.

Note that, in this embodiment, since the multiplier-accumulators MAC1 and MAC2 execute the multiply-accumulate operation of the same number of data pairs as each other in processing of each layer, the multiplier-accumulators set the operation completion signals EXEND1 and EXEND2 to the active level at the same cycle as each other. Therefore, for example, only the operation completion signal EXEND1 may be output to the OR circuit OR2 and the buffer control unit BUFCNT as the completion signal END3.

The OR circuit OR2 outputs the OR logic of the completion signals END3 and DPpEND to the AND circuit AND. The completion signal DPpEND is set to the active level (for example, “1”) by the buffer control unit BUFCNT in a case where all of the data pairs DTp and Wp held in the buffer BUFp are output from the buffer BUFp.

The AND circuit AND outputs an active level (for example, “1”) completion signal END4 to the multiplexer MUX3 in a case where both the outputs of the negative signal NEGP and the OR circuit OR2 are at the active level. For example, the AND circuit AND outputs the active level completion signal END4 in a case where the cumulative values of the multiply-accumulate operation are “0” or less when the multiply-accumulate operation for each layer by the multiplier-accumulators MAC1 and MAC2 is completed.

Furthermore, the AND circuit AND outputs the active level completion signal END4 in a case where the cumulative values of the multiply-accumulate operation are “0” or less when receiving the completion signal DPpEND indicating completion of the outputs of the data pairs DPp and Wp held in the buffer unit BUF. The AND circuit AND outputs the completion signal END4 at the inactive level (for example, “0”) to the multiplexer MUX3 in a case where at least one of the output of the negative signal NEGP or the OR circuit OR2 is at the inactive level.

The multiplexer MUX3 outputs “0” as the activation function ReLU when receiving the active level completion signal END4, and outputs the addition result RSLT as the activation function ReLU when receiving the inactive level completion signal END4. For example, the multiplexer MUX3 outputs “0” or the addition result RSLT as the activation function ReLU every time the multiply-accumulate processing of layers is completed.

The comparator CMP, the OR circuit OR2, the AND circuit AND, and the multiplexer MUX3 are examples of an output setting unit that sets the output value of the activation function ReLU to “0”. The output setting unit sets the output value of the activation function ReLU to “0” before completion of the multiply-accumulate operation of all the data pairs on the basis of predetermined conditions in a case where the number of data pairs DTp and Wp in the buffer unit BUF is less than the number of data pairs DPn and Wp in the buffer unit BUF.

For example, the output setting unit sets the output value of the activation function ReLU to “0” in a case where the comparator CMP outputs the active level negative signal NEGP when the multiply-accumulate operation of all the data pairs DTp and Wp in the buffer unit BUF is completed. Furthermore, the output setting unit sets the output value of the activation function ReLU to “0” when the comparator CMP outputs the active level negative signal NEGP on the basis of the multiply-accumulate operation of the data pair DPn and Wn after completion of the multiply-accumulate operation of all the data pairs DTp and Wp in the buffer unit BUF.

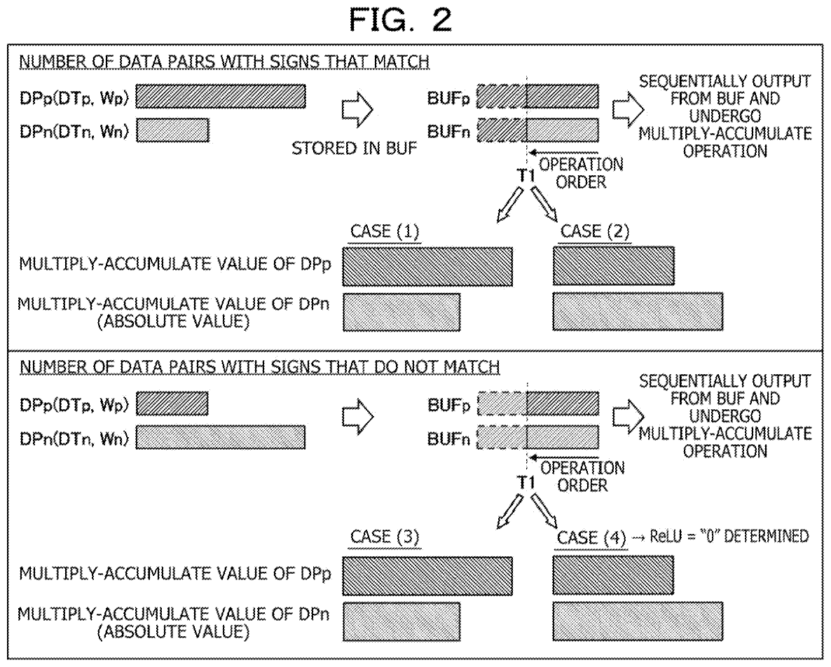

FIG. 2 illustrates an outline of an operation of the arithmetic processing device 10 of FIG. 1. It is assumed that the number of data pairs DPp (DTp and Wp) containing the data DT and the weight W having the signs that match is larger than the number of data pairs DPn (DTn and Wn) containing the data DT and the weight W having the signs that do not match. In this case, the arithmetic processing device 10 stores the data pairs DPp exceeding the size of the buffer BUFp in the buffer BUFn. Thereby, the sizes of the buffers BUFp and BUFn can be fixed without depending on the numbers of data pairs DPp and DPn for calculating the cumulative values by the multiply-accumulate operation.

The multiplier-accumulators MAC1 and MAC2 in FIG. 1 execute the multiply-accumulate operation of the data pairs sequentially output from the buffers BUFp and BUFn in parallel (simultaneously). Thereby, the arithmetic processing device 10 can double an execution speed of the multiply-accumulate operation and halve the time needed for the layer calculation processing, as compared with a case of sequentially executing the multiply-accumulate operation of the data pairs.

The multiply-accumulate operation is executed in parallel with the data pair DPp and DPn. Therefore, at a point of time T1 when execution of the multiply-accumulate operation of a small number of the data pairs DPn is completed, a magnitude relationship between the multiply-accumulate value of the data pairs DPp and the multiply-accumulate value (absolute value) of the data pairs DPn is case (1) or case (2). In this example, it is assumed that the multiply-accumulate value of the data pairs DPp and the multiply-accumulate value of the data pairs DPn are not equal. Also hereinafter, the multiply-accumulate value of the data pairs DPn is assumed to be an absolute value.

In case (1), the multiply-accumulate value of the data pairs DPp is larger than the multiply-accumulate value of the data pairs DPn. In this case, the multiply-accumulate operation results of all the data pairs DPp and DPn become positive values, and the positive value of the multiply-accumulate operation result becomes the output value of the activation function ReLU. Therefore, the arithmetic processing device 10 calculates and accumulates the multiply-accumulate value of all the remaining data pairs DPp, and calculates a positive value that is to be the output value of the activation function ReLU.

In case (2), the multiply-accumulate value of the data pairs DPp is smaller than the multiply-accumulate value of the data pairs DPn. In this case, the multiply-accumulate operation results of all the data pairs DPp and DPn become either a positive value or a negative value according to the cumulative value of the multiply-accumulate operation result of the remaining data pairs DPp. Then, the output value of the activation function ReLU is determined on the basis of the multiply-accumulate operation results of all the data pairs DPp and DPn.

As described above, in case (1) and case (2), the arithmetic processing device 10 executes the multiply-accumulate operation of all the data pairs DPp and DPn. For example, in the case where the multiply-accumulate operation results of all the data pairs DPp and DPn are positive values, the output value of the activation function ReLU is a positive value of the multiply-accumulate operation result. On the other hand, in the case where the multiply-accumulate operation results of all the data pairs DPp and DPn are “0” or less, the output value of the activation function ReLU becomes “0”.

Next, it is assumed that the number of data pairs DPn (DTp and Wp) containing the data DT and the weight W having the signs that match is smaller than the number of data pairs DPn (DTn and Wn) containing the data DT and the weight W having the signs that do not match. The multiply-accumulate operation is executed in parallel with the data pair DPp and DPn. Therefore, at a point of time T1 when execution of the multiply-accumulate operation of a small number of the data pairs DPp is completed, the magnitude relationship between the multiply-accumulate value of the data pairs DPp and the multiply-accumulate value of the data pairs DPn is case (3) or case (4). Also in this example, it is assumed that the multiply-accumulate value of the data pairs DPp and the multiply-accumulate value of the data pairs DPn are not equal.

In case (3), the multiply-accumulate value of the data pairs DPp is larger than the multiply-accumulate value of the data pairs DPn. In this case, the multiply-accumulate operation results of all the data pairs DPp and DPn become either a positive value or a negative value according to the cumulative value of the multiply-accumulate operation result of the remaining data pairs DPn. However, in case (3), since the multiplication result of the data pairs DPn is a negative value, only the cumulative value (absolute value) of the multiply-accumulate operation result of the data pairs DPn increases. Therefore, the arithmetic processing device 10 can determine the output value of the activation function ReLU to be “0” at the point of time when the multiply-accumulate operation results of the data pairs DPp and DPn become “0” or less.

In case (4), the multiply-accumulate value of the data pairs DPp is smaller than the multiply-accumulate value of the data pairs DPn. In this case, the cumulative value increases toward negative side as the multiply-accumulate operation result of the remaining data pairs DPn is accumulated. Therefore, the arithmetic processing device 10 can determine the output value of the activation function ReLU to “0” at the point of time when the case (4) is determined.

In this way, in case (3), the arithmetic processing device 10 may be able to determine the output value of the activation function ReLU to “0” without executing the multiply-accumulate operation of all the data pairs DPp and DPn. In case (4), the arithmetic processing device 10 can determine the output value of the activation function ReLU to “0” without executing the multiply-accumulate operation of all the data pairs DPp and DPn. Therefore, the arithmetic processing device 10 can further increase the execution speed of the multiply-accumulate operation and can further shorten the time needed for the layer calculation processing than halve, as compared with the case of sequentially executing the multiply-accumulate operation of the data pairs.

After storing the data pair DPp in every area (entry) of the buffer BUFp, the arithmetic processing device 10 stores the subsequent data pair DPp in a free space of the buffer BUFn when there is the free space in which the data pair DPn is not stored in the buffer BUFn. Furthermore, after storing the data pair DPn in every area (entry) of the buffer BUFn, the arithmetic processing device 10 stores the subsequent data pair DPn in the free space of the buffer BUFp when there is the free space in which the data pair DPp is not stored in the buffer BUFp.

Thereby, the arithmetic processing device 10 can store the data pairs DPp and DPn of the same number as each other in the buffers BUFp and BUFn of the same size as each other even in a case where the number of data pairs DPp and the number of data pairs DPn are different. The arithmetic processing device 10 can make the numbers of times of the multiply-accumulate operation executed in parallel by the multiplier-accumulators MAC1 and MAC2 equal to each other by setting the number of data pairs DPp and DPn stored in the buffer BUFp and the number of data pairs DPp and DPn stored in the buffer BUFn to be the same. As a result, the arithmetic processing device 10 can minimize the number of times of the multiply-accumulate operation and shorten the execution time of the multiply-accumulate operation as compared with the case where the data pairs DPp and DPn of different numbers from each other are stored in the buffers BUFp and BUFn

For example, it is assumed that ten data pairs DPp (or DPn) can be stored in each of the buffers BUFp and BUFn, and twelve data pairs DPp and eight data pairs DPn are supplied to the buffer unit BUF. In this case, ten data pairs DPp are held in the buffer BUFp, and eight data pairs DPn and two data pairs DPp are held in the buffer BUFn. Then, the arithmetic processing device 10 can calculate the cumulative value by executing the multiply-accumulate operation ten times each by each of the multiplier-accumulators MAC1 and MAC2.

In contrast, in a case where the data pair DPp is stored only in the buffer BUFp and the data pair DPn is stored only in the buffer BUFn, the sizes of the buffers BUFp and BUFn are determined according to the respective maximum numbers of the data pairs DPp and DPn. For example, it is assumed that the buffer BUFp contains twelve data pairs DPp and the buffer BUFn stores eight data pairs DPn.

In this case, twelve data pairs DPp are held in the buffer BUFp and eight data pairs DPn are held in the buffer BUFn. Then, the arithmetic processing device 10 calculates the cumulative values by executing the multiply-accumulate operation twelve times by the multiplier-accumulator MAC1 and executing the multiply-accumulate operation eight times by the multiplier-accumulator MAC2. In this case, by 4m cycles (m is the number of clock cycles needed for one multiply-accumulate operation) in which the multiplier-accumulator MAC1 executes the multiply-accumulate operation and the multiplier-accumulator MAC2 does not execute the multiply-accumulate operation, execution efficiency of the operation is reduced, and the operation time is increased by 2m cycles.

Note that the multiply-accumulate operation results (cumulative values) by the multiplier-accumulators MAC1 and MAC2 are added by the adder ADD2 in FIG. 1. Therefore, regardless of whether the data pair DPp is held in any of the buffer BUFp or BUFn, the final cumulative value output from the adder ADD does not change.

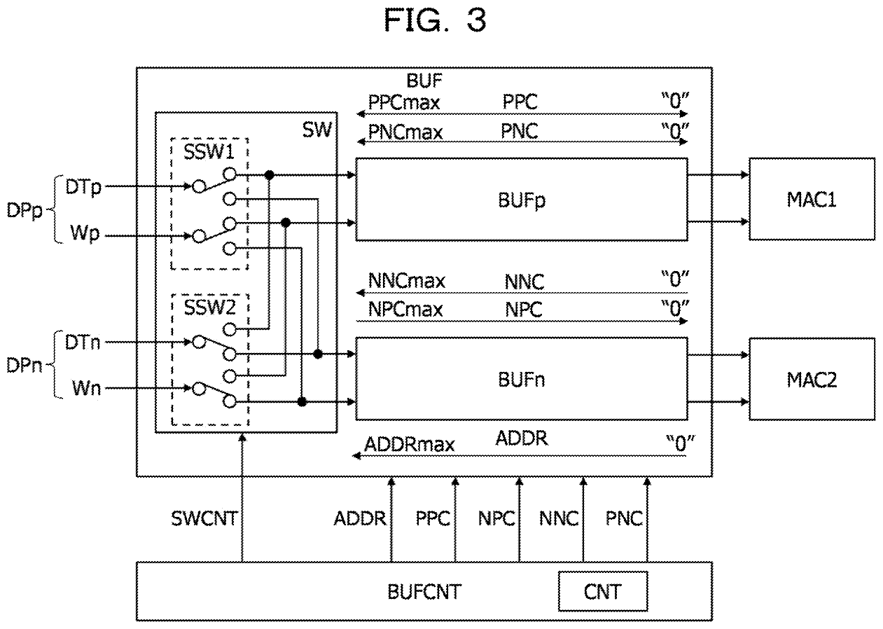

FIG. 3 illustrates an example of the buffer unit BUF of FIG. 1. As described with reference to FIG. 1, the buffer unit BUF includes the switch unit SW and the buffers BUFp and BUFn controlled by the buffer control unit BUFCNT.

The pointer value PPC indicates the position of the entry of the buffer BUFp that stores the data pair DPp, and also indicates the number of data pairs DPp held in the buffer BUFp. The pointer value PNC indicates the position of the entry of the buffer BUFp that stores the data pair DPn. The buffer control unit BUFCNT sequentially increments the pointer value PPC from “0” every time the data pair DPp is stored in the buffer BUFp. The buffer control unit BUFCNT sequentially decrements the pointer value PNC from a maximum value PNCmax every time the data pair DPn is stored in the buffer BUFp.

The pointer value NNC indicates the position of the entry of the buffer BUFn that stores the data pair DPn, and also indicates the number of data pairs DPn held in the buffer BUFn. The pointer value NPC indicates the position of the entry in the buffer BUFn that stores the data pair DPp. The buffer control unit BUFCNT sequentially increments the pointer value NNC from “0” every time the data pair DPn is stored in the buffer BUFn. The buffer control unit BUFCNT sequentially decrements the pointer value NPC from a maximum value NPCmax every time the data pair DPp is stored in the buffer BUFn.

The counter value CNT is used in the buffer control unit BUFCNT and indicates the total numbers of the data pairs DPp and DPn held in the buffers BUFp and BUFn. The buffer control unit BUFCNT sequentially increments the counter value CNT from “0” every time the data pair DPp or DPn is stored in the buffer BUFp or BUFn.

The address value ADDR indicates the positions of the entries of the buffers BUFp and BUFn. The buffer control unit BUFCNT sequentially increments the address value ADDR from “0” every time the data pairs (two of DPp and DPn) respectively held in the buffers BUFp and BUFn are output from the buffers BUFp and BUFn.

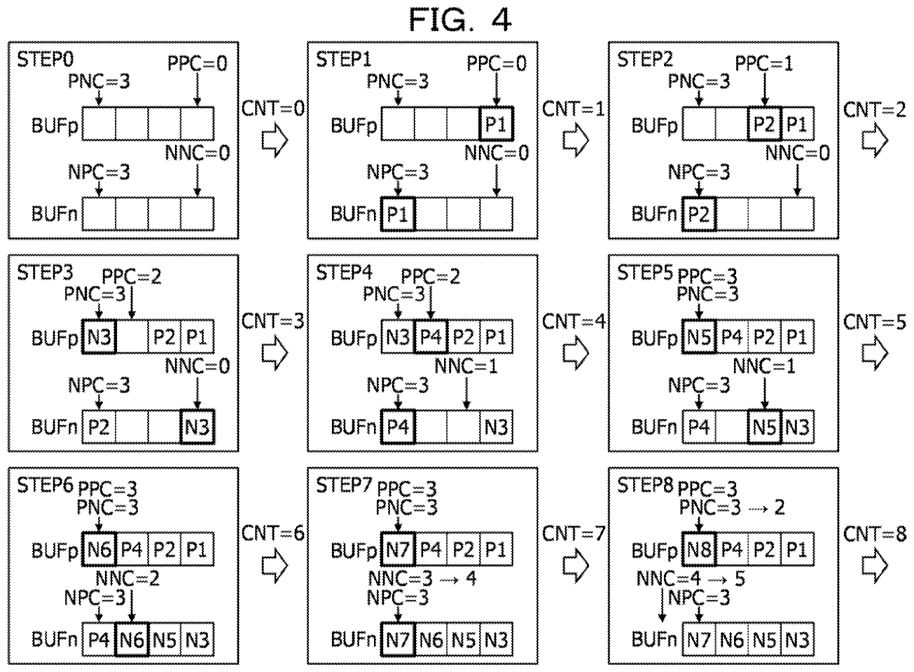

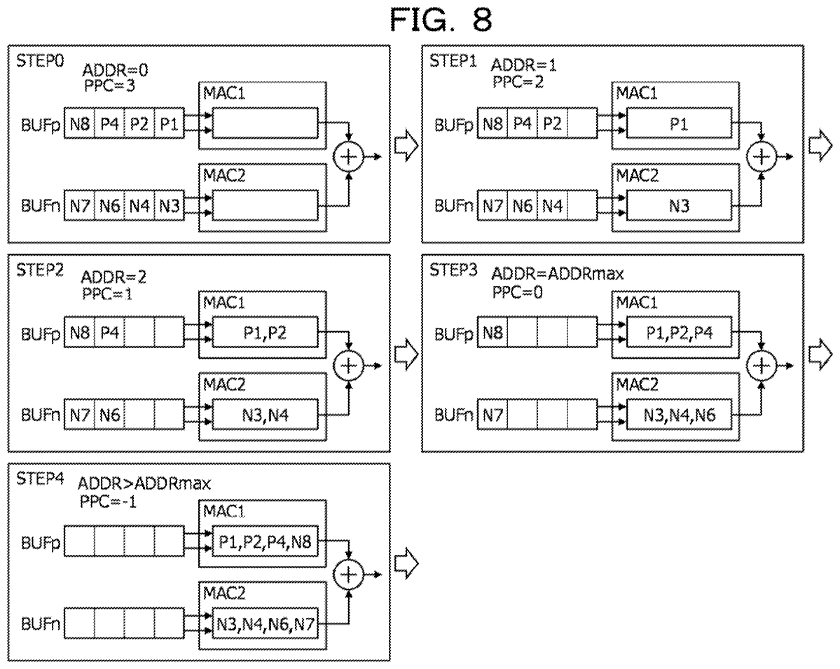

Examples of the data pairs DPp and DPn, the counter value CNT, and the pointer values PPC, NPC, NNC, and PNC stored in the buffers BUFp and BUFn are illustrated in FIGS. 4 to 7. Furthermore, examples of the data pairs DPp and DPn, the address value ADDR, and the pointer value PPC output from the buffers BUFp and BUFn will be described with reference to FIGS. 8 to 10.

The switch unit SW has subswitches SSW1 and SSW2. The subswitch SSW1 supplies the data pair DPp to either the buffer BUFp or the buffer BUFn according to the switch control signal SWCNT. The subswitch SSW2 supplies the data pair DPn to either the buffer BUFp or the buffer BUFn according to the switch control signal SWCNT. For example, the buffer control unit BUFCNT generates the 2-bit switch control signal SWCNT and controls each of the subswitches SSW1 and SSW2.

For example, the buffer control unit BUFCNT controls the subswitch SSW1 in order to store the subsequent data pair DPp in the buffer BUFn after storing the data pair DPp in every area of the buffer BUFp. Furthermore, the buffer control unit BUFCNT controls the subswitch SSW2 in order to store the subsequent data pair DPn in the buffer BUFp after storing the data pair DPn in every area of the buffer BUFn.

Thereby, even in the case of storing the data pairs DPp and DPn of different numbers from each other in the buffers BUFp and BUFn having the same size, the arithmetic processing device 10 can store the data pairs DPp and DPn of equal numbers in the buffers BUFp and BUFn by the switch unit SW. Therefore, the arithmetic processing device 10 can make the numbers of times of the operation of the multiplier-accumulators MAC1 and MAC2 respectively connected to the buffers BUFp and BUFn equal to each other even in the case where the numbers of the data pairs DPp and DPn are different from each other. As a result, the arithmetic processing device 10 can shorten the time needed for the calculation processing of the layer using the activation function ReLU.

FIG. 4 illustrates an example of the input operation of the buffer unit BUF of FIG. 1. FIG. 4 onward illustrates an example in which each of the buffers BUFp and BUFn has four entries holding four data pairs DPp (or DPn), and the buffer unit BUF can hold eight data pairs DPp (or DPn).

A maximum value PPCmax of the pointer value PPC is “3”, and a maximum value NNCmax of the pointer value NNC is “3”. A maximum value CNTmax of the counter value CNT is “7”. Furthermore, in FIG. 4 onward, the data pair DPp is also referred to as a data pair Pj (j is one of “1” to “8”), and the data pair DPn is also referred to as a data pair Nk (k is one of “1” to “8”).

In step STEP0, which is an initial state, the buffer control unit BUFCNT performs initialization to the counter value CNT=“0”, the pointer values PPC and NNC=“0”, and the pointer values NPC and PNC=“3”. Next, in step STEP1, the buffer control unit BUFCNT stores a data pair P1 to be supplied to the buffer unit BUF via the multiplexer MUX1 in the entry indicated by the pointer value PPC in the buffer BUFp. Furthermore, the buffer control unit BUFCNT stores the data pair P1 to be supplied to the buffer unit BUF in the entry indicated by the pointer value NPC in the buffer BUFn.

The data pair P1 stored in the buffer BUFn is a dummy held value and is stored in order to avoid complication of the operation flow. Thereafter, the buffer control unit BUFCNT increments the counter value CNT by “1” and sets the value to “1” and increments the pointer value PPC by “1” and sets the value to “1”.

In step STEP2, the buffer control unit BUFCNT stores a data pair P2 in the entry indicated by the pointer value PPC in the buffer BUFp and the entry indicated by the pointer value NPC in the buffer BUFn, as in step STEP1. Thereafter, the buffer control unit BUFCNT increments the counter value CNT by “1” and sets the value to “2” and increments the pointer value PPC by “1” and sets the value to “2”.

In step STEP3, the buffer control unit BUFCNT stores a data pair N3 to be supplied to the buffer unit BUF via the multiplexer MUX2 in the entry indicated by the pointer value NNC in the buffer BUFn. Furthermore, the buffer control unit BUFCNT stores the data pair N3 to be supplied to the buffer unit BUF in the entry indicated by the pointer value PNC in the buffer BUFp. Thereafter, the buffer control unit BUFCNT increments the counter value CNT by “1” and sets the value to “3” and increments the pointer value PPC by “1” and sets the value to “1”.

The operation of step STEP4 is similar to the operation of step STEP2, and the operations of steps STEP5, STEP6, and STEP7 are similar to the operation of step STEP3. In step STEP7, the buffer BUFn holds the data pairs N3, N5, N6, and N7 in all the entries, respectively. The buffer BUFp holds the data pairs P1, P2, and P4 in three entries, and only one entry holding the data pair N7 is free.

At the end of step STEP7, the buffer control unit BUFCNT increments the pointer value NNC by “1” and sets the value to “4”, which is larger than the maximum value NNCmax=“3”. The pointer value NNC larger than the maximum value NNCmax indicates that the data pair Nk has been stored in every entry in the buffer BUFn.

Next, in step STEP8, the buffer unit BUF receives a data pair N8 via the multiplexer MUX2. Since there is no free entry in the buffer BUFn, the buffer control unit BUFCNT stores the data pair N8 only in the entry indicated by the pointer value PNC in the buffer BUFp. The data pair Nk stored in buffer BUFp after there are no more free entries in the buffer BUFn is a valid held value, not a dummy.

The buffer control unit BUFCNT decrements the pointer value PNC by “1” in a case where the data pair Nk is stored in the buffer BUFp when the pointer value NNC exceeds the maximum value NNCmax=“3”. Thereafter, the buffer control unit BUFCNT increments the pointer value NNC by “1” and sets the value to “5”, and increments the counter value CNT by “1” and sets the value to “8”, which is larger than the maximum value CNTmax.

The buffer control unit BUFCNT determines that the data pair has been stored in every entry in the buffer unit because the counter value CNT has exceeded the maximum value CNTmax, and stops the input operation of the data pair to the buffer unit BUF.

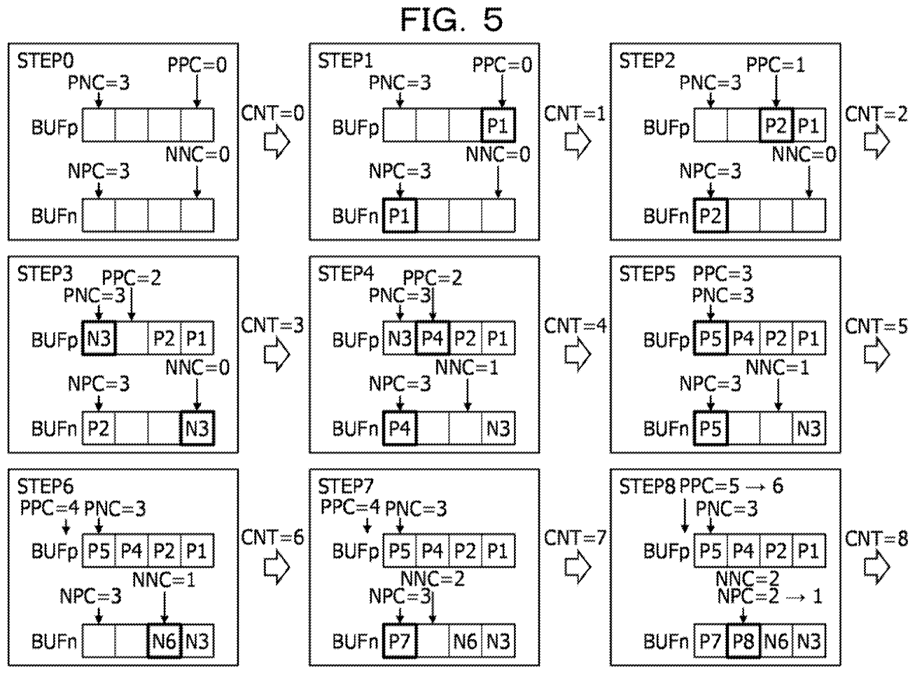

FIG. 5 illustrates another example of the input operation of the buffer unit BUF of FIG. 1. Detailed description of operations similar to those in FIG. 4 is omitted. The operations from step STEP0 to step STEP4 are the same as those in FIG. 4.

In step STEP5, the buffer unit BUF stores the data pair P5 in the entry indicated by the pointer value PPC in the buffer BUFp and the entry indicated by the pointer value NPC in the buffer BUFn, as in steps STEP2 and STEP4. Thereby, the buffer BUFp holds the data pairs P1, P2, P4, and P5 in all the entries, respectively.

Thereafter, the buffer control unit BUFCNT increments the counter value CNT by “1” and sets the value to “5”. The buffer control unit BUFCNT increments the pointer value PPC by “1” and sets the value to “4”, which is larger than the maximum value PPCmax=“3”. The pointer value PPC larger than the maximum value PPCmax indicates that the data pair Pj has been stored in every entry in the buffer BUFp.

Next, in step STEP6, the buffer control unit BUFCNT stores a data pair N6 to be supplied to the buffer unit BUF via the multiplexer MUX2 in the entry indicated by the pointer value NNC in the buffer BUFn. Since the pointer value PPC has exceeded the maximum value PPCmax, the buffer control unit BUFCNT suppresses storage of the data pair N6 in the buffer BUFp. Thereafter, the buffer control unit BUFCNT increments the counter value CNT by “1” and sets the value to “6” and increments the pointer value NNC by “1” and sets the value to “2”.

Next, in step STEP7, the buffer unit BUF receives a data pair P7 via the multiplexer MUX1. Since there is no free entry in the buffer BUFp, the buffer control unit BUFCNT stores the data pair P7 only in the entry indicated by the pointer value NPC in the buffer BUFn. The data pair Pj stored in buffer BUFn after there are no more free entries in the buffer BUFp is a valid held value, not a dummy.

The buffer control unit BUFCNT decrements the pointer value NPC by “1” in a case where the data pair Pj is stored in the buffer BUFn when the pointer value PPC exceeds the maximum value PPCmax=“3”. Thereafter, the buffer control unit BUFCNT increments the pointer value PPC by “1” and sets the value to “5”, and increments the counter value CNT by “1” and sets the value to “7”.

The operation of step STEP8 is similar to that of step STEP7. Since the pointer value PPC exceeds the maximum value NNCmax=“3”, the buffer control unit BUFCNT stores the data pair P8 received by the buffer unit BUF only in the entry indicated by the pointer value NPC in the buffer BUFn.

Since the data pair P8 is stored in the buffer BUFn when the pointer value PPC exceeds the maximum value PPCmax=“3”, the buffer control unit BUFCNT decrements the pointer value NPC by “1” and sets the value to “1”. Thereafter, the buffer control unit BUFCNT increments the pointer value PPC by “1” and sets the value to “6”, and increments the counter value CNT by “1” and sets the value to “8”, which is larger than the maximum value CNTmax.

The buffer control unit BUFCNT recognizes that the data pair has been stored in every entry in the buffer unit BUF because the counter value CNT has exceeded the maximum value CNTmax, and stops the input operation of the data pair to the buffer unit BUF.

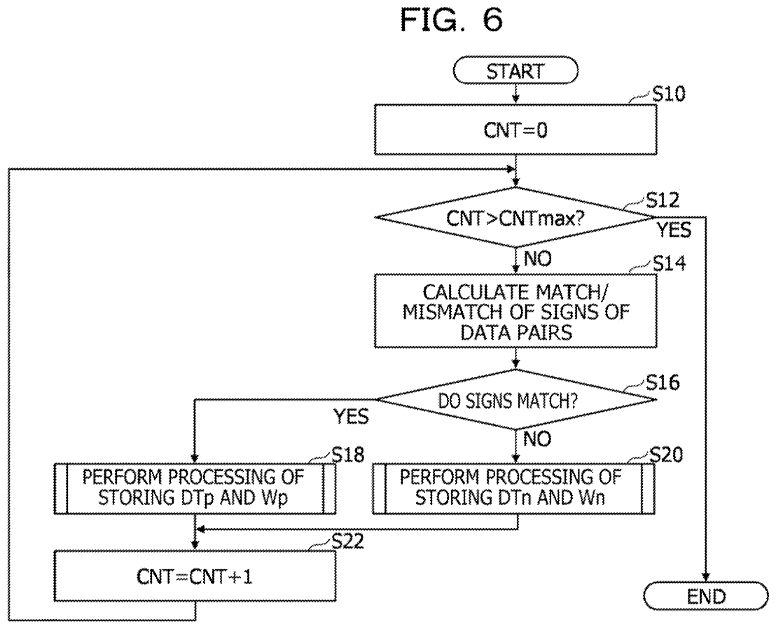

FIG. 6 illustrates an example of a flow of the input operation of the buffer unit BUF of FIG. 1. For example, FIG. 6 illustrates an arithmetic processing method of the arithmetic processing device 10. First, in step S10, the buffer control unit BUFCNT initializes the counter value CNT to “0”. Next, in step S12, the buffer control unit BUFCNT terminates the input operation of the buffer unit BUF in the case where the counter value CNT exceeds the maximum value CNTmax, and executes step S14 in the case where the counter value CNT does not exceed the maximum value CNTmax.

In step S14, the buffer control unit BUFCNT causes the exclusive OR circuit XOR to calculate the sign match or mismatch of the data pairs. Next, in step S16, the buffer control unit BUFCNT executes step S18 in the case where the signs of the data pairs match, and executes step S20 in the case where the signs of the data pairs do not match.

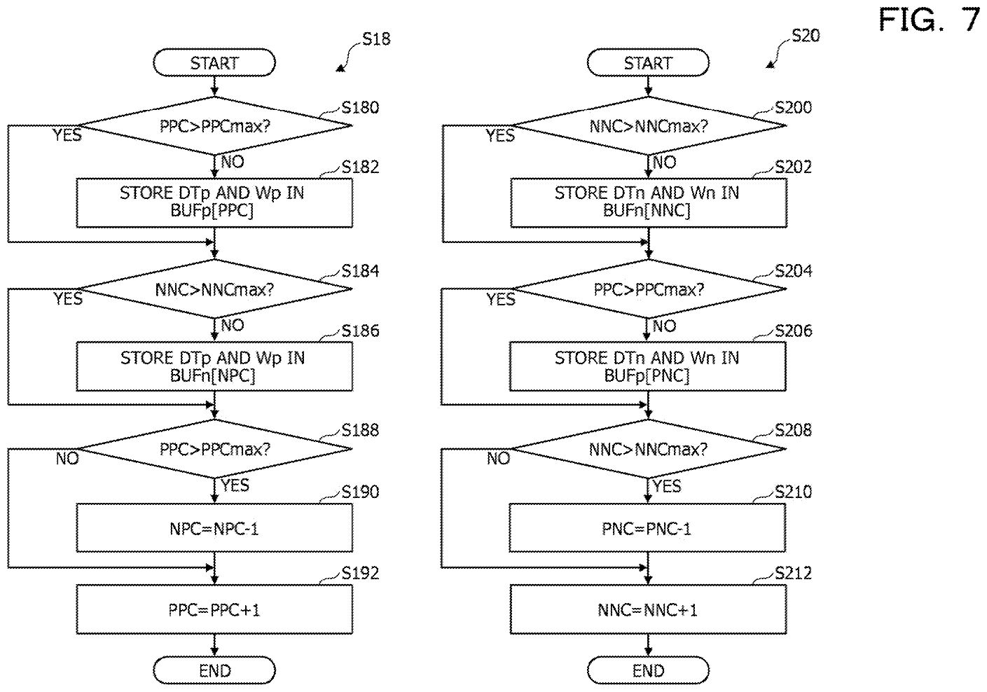

In step S18, the buffer control unit BUFCNT executes the operation of step S22 after executing the processing of storing the data pairs DPp and Wp in the buffer unit BUF. An example of the operation of step S18 is illustrated in FIG. 7. In step S20, the buffer control unit BUFCNT executes the operation of step S22 after executing the processing of storing the data pairs DPn and Wn in the buffer unit BUF. An example of the operation of step S20 is illustrated in FIG. 8.

Next, in step S22, the buffer control unit BUFCNT increments the counter value CNT by “1” and then returns to the operation of step S12.

FIG. 7 illustrates an example of the operations of S18 and S20 in FIG. 6. In the operation of step S18, first, in step S180, the buffer control unit BUFCNT executes step S184 in the case where the pointer value PPC exceeds the maximum value PPCmax. The buffer control unit BUFCNT executes step S182 in the case where the pointer value PPC does not exceed the maximum value PPCmax. In step S182, the buffer control unit BUFCNT stores the data pairs DTp and Wp in the entries indicated by the pointer value PPC in the buffer BUFp, and then executes step S184.

In step S184, the buffer control unit BUFCNT executes step S188 in the case where the pointer value NNC exceeds the maximum value NNCmax, and executes step S186 in the case where the pointer value NNC does not exceed the maximum value NNCmax. In step S186, the buffer control unit BUFCNT stores the data pairs DTp and Wp in the entries indicated by the pointer value NPC in the buffer BUFn, and then executes step S188.

In step S188, the buffer control unit BUFCNT executes step S190 in the case where the pointer value PPC exceeds the maximum value PPCmax, and executes step S192 in the case where the pointer value PPC does not exceed the maximum value PPCmax. In step S190, the buffer control unit BUFCNT decrements the pointer value NPC by “1” and then executes step S192.

In step S192, the buffer control unit BUFCNT increments the pointer value PPC by “1” and terminates the operation of step S18. For example, the buffer control unit BUFCNT executes step S22 in FIG. 6.

Meanwhile, in the operation of step S20, first, in step S200, the buffer control unit BUFCNT executes step S204 in the case where the pointer value NNC exceeds the maximum value NNCmax. The buffer control unit BUFCNT executes step S202 in the case where the pointer value NNC does not exceed the maximum value NNCmax. In step S202, the buffer control unit BUFCNT stores the data pairs DTn and Wn in the entries indicated by the pointer value NNC in the buffer BUFn, and then executes step S204.

In step S204, the buffer control unit BUFCNT executes step S208 in the case where the pointer value PPC exceeds the maximum value PPCmax, and executes step S206 in the case where the pointer value PPC does not exceed the maximum value PPCmax. In step S206, the buffer control unit BUFCNT stores the data pairs DTn and Wn in the entries indicated by the pointer value PNC in the buffer BUFp, and then executes step S208.

In step S208, the buffer control unit BUFCNT executes step S210 in the case where the pointer value NNC exceeds the maximum value NNCmax, and executes step S212 in the case where the pointer value NNC does not exceed the maximum value NNCmax. In step S210, the buffer control unit BUFCNT decrements the pointer value PNC by “1” and then executes step S212.

In step S212, the buffer control unit BUFCNT increments the pointer value NNC by “1” and terminates the operation of step S20. For example, the buffer control unit BUFCNT executes step S22 in FIG. 6.

FIG. 8 illustrates an example of the output operation of the buffer unit BUF of FIG. 1. Holding states of the data pairs of the buffers BUFp and BUFn in step STEP0, which is the initial state, are the same as the holding states of the data pairs of the buffers BUFp and BUFn in step STEP8 of FIG. 4. Furthermore, the pointer value PPC in step STEP0 is the same as the pointer value PPC after execution of step STEP8 in FIG. 4. The buffer control unit BUFCNT resets the address value ADDR to “0” in step STEP0.

In step STEP1, the buffer control unit BUFCNT reads the data pairs P1 and N3 in parallel from the entries indicated by the address values ADDR=“0” in the buffers BUFp and BUFn, and outputs the data pairs to the multiplier-accumulator MAC1 and MAC2, respectively. The multiplier-accumulator MAC1 executes the multiply-accumulate operation of the data pair P1, and the multiplier-accumulator MAC2 executes the multiply-accumulate operation of the data pair N3. The buffer control unit BUFCNT increments the address value ADDR by “1” and sets the value to “1”, and decrements the pointer value PPC by “1” and sets the value to “2”.

The arithmetic processing device 10 can read the data pairs Pj and Nk in parallel from the buffers BUFp and BUFn and execute the multiply-accumulate operation in parallel. Therefore, the arithmetic processing device 10 can double the execution speed of the multiply-accumulate operation and halve the time needed for the layer calculation processing, as compared with a case of sequentially executing the multiply-accumulate operation of the data pairs Pj and Nk.

Next, in step STEP2, the buffer control unit BUFCNT reads the data pairs P2 and N4 in parallel from the entries indicated by the address values ADDR=“1” in the buffers BUFp and BUFn, and outputs the data pairs to the multiplier-accumulator MAC1 and MAC2, respectively. The multiplier-accumulator MAC1 executes the multiply-accumulate operation of the data pair P2 and accumulates the multiply-accumulate operation result with the multiply-accumulate operation result of the data pair P1. The multiplier-accumulator MAC2 executes the multiply-accumulate operation of the data pair N4 and accumulates the multiply-accumulate operation result with the multiply-accumulate operation result of the data pair N3. The buffer control unit BUFCNT increments the address value ADDR by “1” and sets the value to “2”, and decrements the pointer value PPC by “1” and sets the value to “1”.

In step STEP3, the buffer control unit BUFCNT reads the data pairs P4 and N6 in parallel from the buffers BUFp and BUFn, and causes the multiplier-accumulators MAC1 and MAC2 to execute the multiply-accumulate operation, as in steps STEP1 and STEP2. The buffer control unit BUFCNT increments the address value ADDR by “1” and sets the value to “3” (=the maximum value ADDRmax), and decrements the pointer value PPC by “1” and sets the value to “0”.

In step STEP4, the buffer control unit BUFCNT determines that the multiply-accumulate operation of all the data pairs Pj held in the buffer BUFp has been executed in the case where the pointer value PPC is “0” or less. Then, the arithmetic processing device 10 sets the output value of the activation function ReLU to “0” and terminates the output operation in FIG. 8 in the case where the multiply-accumulate operation result by the multiplier-accumulator MAC1 is equal to or less than an absolute value of the multiply-accumulate operation result by the multiplier-accumulator MAC2. For example, the buffer control unit BUFCNT terminates the output operation of FIG. 8 without reading the data pairs N8 and N7 from the buffers BUFp and BUFn.

In the case where the number of data pairs Pj with the multiplication result that is the positive value is less than the number of data pairs Nj with the multiplication result that is the negative value, the multiply-accumulate operation result gradually decreases by the subsequent multiply-accumulate operation after completion of the multiply-accumulate operation of all the data pairs Pj. Therefore, in the case where the multiply-accumulate operation result by the multiplier-accumulator MAC1 is equal to or less than the absolute value of the multiply-accumulate operation result by the multiplier-accumulator MAC2 at the start of step STEP4, the output value of the activation function ReLU will always be “0” even if the multiply-accumulate operation is continued.

Therefore, the arithmetic processing device 10 can further increase the execution speed of the multiply-accumulate operation and can further shorten the time needed for the layer calculation processing, as compared with the case of reading all the data pairs Pj and Nk from the buffers BUFp and BUFn and sequentially executing the multiply-accumulate operation.

Meanwhile, in the case where the multiply-accumulate operation result by the multiplier-accumulator MAC1 is larger than the absolute value of the multiply-accumulate operation result by the multiplier-accumulator MAC2 at the start of step STEP4, the buffer control unit BUFCNT reads the data pairs N8 and N7 in parallel from the buffers BUFp and BUFn. Then, the buffer control unit BUFCNT causes the multiplier-accumulators MAC1 and MAC2 to execute the multiply-accumulate operation of the read data pairs N8 and N7. The buffer control unit BUFCNT increments the address value ADDR by “1” and sets the value to “4”, and decrements the pointer value PPC by “1” and sets the value to “−1”.

The buffer control unit BUFCNT determines that the multiply-accumulate operation has been executed using all the data pairs Pj and Nk held in the buffers BUFp and BUFn because the address value ADDR has exceeded the maximum value ADDRmax, and terminates the output operation in FIG. 8. Then, the arithmetic processing device 10 sets the positive value to the output value of the activation function ReLU in the case where the multiply-accumulate operation result is the positive value, and sets “0” to the output value of the activation function ReLU in the case where the multiply-accumulate operation result is “0” or less.

Note that, in a case where the number of entries in the buffers BUFp and BUFn is larger than 4, the address value ADDR is equal to or less than the maximum value ADDRmax at the time of completion of step STEP4. In this case, the buffer control unit BUFCNT reads two data pairs Nk from the buffers BUFp and BUFn in parallel similarly to step STEP3 until the address value ADDR exceeds the maximum value ADDRmax, and causes the multiplier-accumulators MAC1 and MAC2 to execute the multiply-accumulate operation.

Then, the arithmetic processing device 10 sets the output value of the activation function ReLU to “0” and terminates the output operation in FIG. 8 at the point of time when the multiply-accumulate operation result by the multiplier-accumulator MAC1 is equal to or less than an absolute value of the multiply-accumulate operation result by the multiplier-accumulator MAC2. As a result, the arithmetic processing device 10 can further increase the execution speed of the multiply-accumulate operation and can further shorten the time needed for the layer calculation processing, as compared with the case of reading all the data pairs Pj and Nk from the buffers BUFp and BUFn and sequentially executing the multiply-accumulate operation.

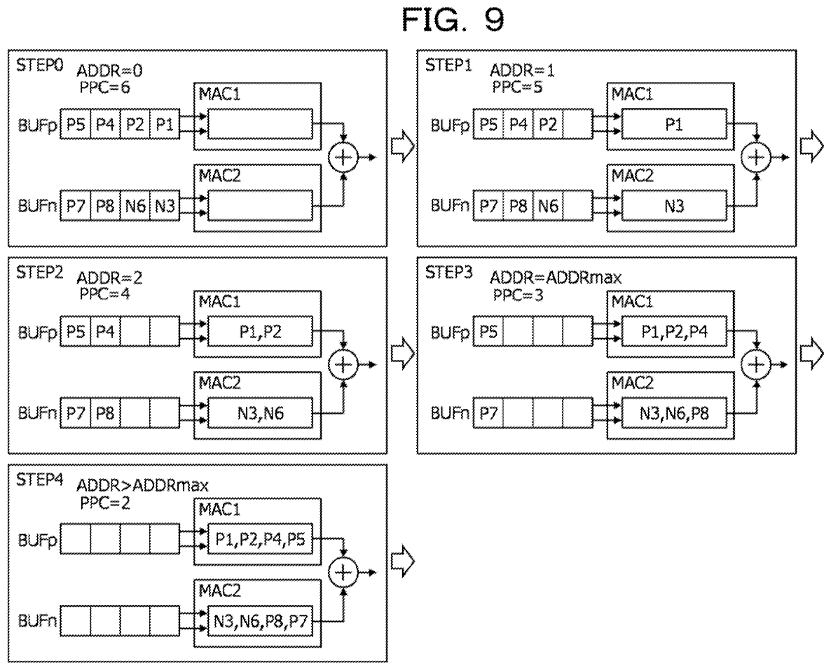

FIG. 9 illustrates another example of the output operation of the buffer unit BUF of FIG. 1. Detailed description of operations similar to those in FIG. 8 is omitted. The operations from step STEP0 to step STEP4 in FIG. 9 are similar to the operations from step STEP0 to step STEP4 in FIG. 8 except that the data pairs Pj, Nk and the pointer value PPC read from the buffers BUFp and BUFn are different.

In FIG. 9, the number of data pairs Pj with the multiplication result that is a positive value is larger than the number of data pairs Nj with the multiplication result that is a negative value. In this case, the multiply-accumulate operation result sequentially increases by the subsequent multiply-accumulate operation after completion of the multiply-accumulate operation of all the data pairs Nk. However, it is not known whether the multiply-accumulate operation result will be finally a positive value or “0” or less until all the data pairs Pj and Nk are read from the buffers BUFp and BUFn and the multiply-accumulate operation is performed. Therefore, the buffer control unit BUFCNT continues reading the data pairs Pj and Nk from the buffers BUFp and BUFn and causes the multiplier-accumulators MAC1 and MAC3 to execute the multiply-accumulate operation until the address value ADDR exceeds the maximum value ADDRmax.

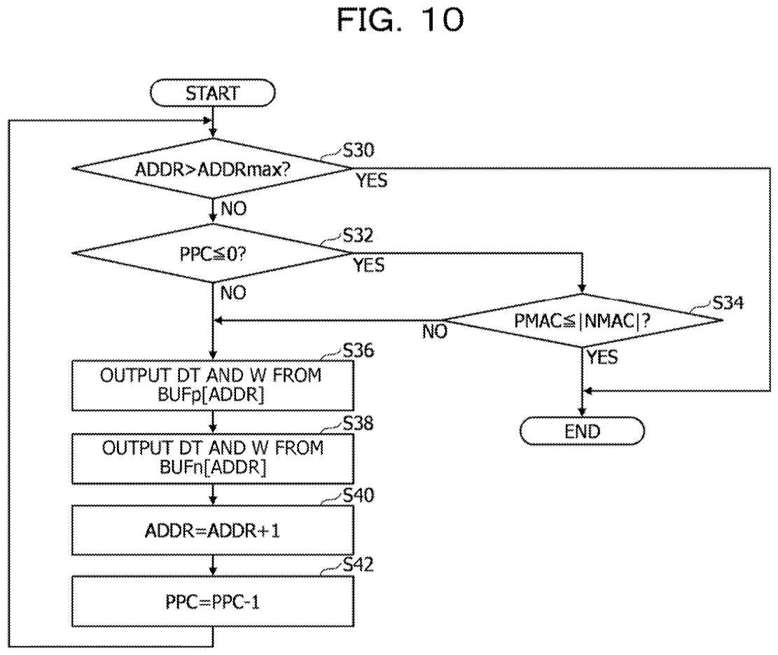

FIG. 10 illustrates an example of a flow of the output operation of the buffer unit BUF of FIG. 1. For example, FIG. 10 illustrates an arithmetic processing method of the arithmetic processing device 10. First, in step S30, the buffer control unit BUFCNT terminates the output operation of FIG. 10 in the case where the address value ADDR exceeds the maximum value ADDRmax, and executes step S32 in the case where the address value ADDR does not exceed the maximum value ADDRmax.

In step S32, the buffer control unit BUFCNT executes step S34 in the case where the pointer value PPC is “0” or less, and executes step S3 in the case where the pointer value PPC is “1” or larger. In step S34, the buffer control unit BUFCNT terminates the output operation of FIG. 10 in the case where the multiply-accumulate operation result of the data pair Pj at this point of time is equal to or less than the absolute value of the multiply-accumulate operation result of the data pair Pk. In this case, the arithmetic processing device 10 sets the output value of the activation function ReLU to “0”.

In step S36, the buffer control unit BUFCNT outputs the data pairs DT and W from the entry indicated by the address value ADDR in the buffer BUFp. Next, in step S38, the buffer control unit BUFCNT outputs the data pairs DT and W from the entry indicated by the address value ADDR in the buffer BUFn. In steps S36 and S38, the buffer control unit BUFCNT reads the data pairs DT and W from the buffers BUFp and BUFn in parallel using the common address value ADDR. Note that the data pair DT and W read from the buffer BUFp is not limited to the data pair DTp and Wp. Similarly, the data pair DT and W read from the buffer BUFn is not limited to the data pair DTn and Wn.

Next, in step S40, the buffer control unit BUFCNT increments the address value ADDR by “1”. Next, in step S42, the buffer control unit BUFCNT decrements the pointer value PPC by “1”, and then returns to the operation of step S30.

As described above, in this embodiment, the multiplier-accumulators MAC1 and MAC2 execute the multiply-accumulate operation of the data pairs sequentially output from the buffers BUFp and BUFn in parallel (simultaneously). Thereby, the arithmetic processing device 10 can double an execution speed of the multiply-accumulate operation and halve the time needed for the layer calculation processing, as compared with a case of sequentially executing the multiply-accumulate operation of the data pairs.

In case (1) and case (2) of FIG. 2, the arithmetic processing device 10 can reliably acquire the output value of the activation function ReLU by calculating the output value of the activation function ReLU after executing the multiply-accumulate operation of all the data pairs DPp and DPn.

In case (3) of FIG. 2, the arithmetic processing device 10 may be able to determine the output value of the activation function ReLU to “0” without executing the multiply-accumulate operation of all the data pairs DPp and DPn. In case (4) of FIG. 2, the arithmetic processing device 10 can determine the output value of the activation function ReLU to “0” without executing the multiply-accumulate operation of all the data pairs DPp and DPn. Therefore, the arithmetic processing device 10 can further increase the execution speed of the multiply-accumulate operation and can further shorten the time needed for the layer calculation processing than halve, as compared with the case of sequentially executing the multiply-accumulate operation of the data pairs.

After storing the data pair DPp in every area of the buffer BUFp, the arithmetic processing device 10 stores the subsequent data pair DPp in the free space of the buffer BUFn. Furthermore, after storing the data pair DPn in every area of the buffer BUFn, the arithmetic processing device 10 stores the subsequent data pair DPn in the free space of the buffer BUFp. Thereby, the arithmetic processing device 10 can store the data pairs DPp and DPn of the same number as each other in the buffers BUFp and BUFn of the same size as each other even in a case where the number of data pairs DPp and the number of data pairs DPn are different.

The arithmetic processing device 10 can make the numbers of times of the multiply-accumulate operation executed in parallel by the multiplier-accumulators MAC1 and MAC2 equal to each other by setting the number of data pairs DPp and DPn stored in the buffer BUFp and the number of data pairs DPp and DPn stored in the buffer BUFn to be the same. As a result, the arithmetic processing device 10 can minimize the number of times of the multiply-accumulate operation and shorten the execution time of the multiply-accumulate operation as compared with the case where the data pairs DPp and DPn of different numbers from each other are stored in the buffers BUFp and BUFn

Moreover, even in the case of storing the data pairs DPp and DPn of different numbers from each other in the buffers BUFp and BUFn having the same size, the arithmetic processing device 10 can store the data pairs DPp and DPn of equal numbers in the buffers BUFp and BUFn by the switch unit SW. Therefore, the arithmetic processing device 10 can make the numbers of times of the operation of the multiplier-accumulators MAC1 and MAC2 respectively connected to the buffers BUFp and BUFn equal to each other even in the case where the numbers of the data pairs DPp and DPn are different from each other. As a result, the arithmetic processing device 10 can shorten the time needed for the calculation processing of the layer using the activation function ReLU.

From the detailed description above, characteristics and advantages of the embodiments will become apparent. This intends that claims cover the characteristics and advantages of the embodiment described above without departing from the spirit and the scope of the claims. Furthermore, one of ordinary knowledge in the technical field may easily achieve various improvements and modifications. Therefore, there is no intention to limit the scope of the inventive embodiments to those described above, and the scope of the inventive embodiment may rely on appropriate improvements and equivalents included in the scope disclosed in the embodiment.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. An arithmetic processing device comprising:
one or more memories; and
one or more processors coupled to the one or more memories and the one or more processors configured to:
compare a sign of first data and a sign of second data for each of data pairs of the first data and the second data,
control writing and reading of the data pairs to a first buffer and a second buffer, the first buffer preferentially holding a first data pair whose signs match than a second data pair whose signs do not match, the second buffer preferentially holding the second data pair than the first data pair,
execute a multiply-accumulate operation of data pairs sequentially output from the first buffer and data pairs sequentially output from the second buffer in parallel,
add an operation result of the multiplier-accumulate operation of the data pairs output from the first buffer and an operation result of the multiplier-accumulate operation of the data pairs output from the second buffer, and
set an output value to 0 in a case where the number of the first data pairs held in the first buffer and the second buffer is smaller than the number of the second data pairs held in the first buffer and the second buffer, and a result of the addition when the multiply-accumulate operation of the first data pair is completed is 0 or less.

2. The arithmetic processing device according to claim 1, wherein the one or more processors are further configured to
set the output value to 0 at timing when the result of the adding becomes 0 or less in a case where the addition result is a positive value when the multiply-accumulate operation of the first data pair is completed.

3. The arithmetic processing device according to claim 1, wherein the one or more processors are further configured to
set the output value according to the result of the adding of when the multiply-accumulate operation of the first data pair and the second data pair is completed.

4. The arithmetic processing device according to claim 1, wherein
the first buffer stores a subsequent second data pair in a case where there is a free space in the first buffer and there is no space in the second buffer, and
the second buffer stores a subsequent first data pair in a case where there is a free space in the second buffer and there is no space in the first buffer.

5. The arithmetic processing device according to claim 4, wherein the one or more processors are further configured to:
output the first data and the second data to the first buffer as the first data pair, or output the first data and the second data to the second buffer as the second data pair, based on a result of the comparing, and
switch an output destination of the first data pair from the first buffer to the second buffer, or the output destination of the second data pair from the second buffer to the first buffer.

6. An arithmetic processing method for a computer to execute a process comprising:
comparing a sign of first data and a sign of second data for each of data pairs of the first data and the second data;
controlling writing and reading of the data pairs to a first buffer and a second buffer, the first buffer preferentially holding a first data pair whose signs match than a second data pair whose signs do not match, the second buffer preferentially holding the second data pair than the first data pair;
executing a multiply-accumulate operation of data pairs sequentially output from the first buffer and data pairs sequentially output from the second buffer in parallel;
adding an operation result of the multiplier-accumulate operation of the data pairs output from the first buffer and an operation result of the multiplier-accumulate operation of the data pairs output from the second buffer; and
setting an output value to 0 in a case where the number of the first data pairs held in the first buffer and the second buffer is smaller than the number of the second data pairs held in the first buffer and the second buffer, and a result of the addition when the multiply-accumulate operation of the first data pair is completed is 0 or less.

7. A non-transitory computer-readable storage medium storing an arithmetic processing program that causes at least one computer to execute a process, the process comprising:
comparing a sign of first data and a sign of second data for each of data pairs of the first data and the second data;
controlling writing and reading of the data pairs to a first buffer and a second buffer, the first buffer preferentially holding a first data pair whose signs match than a second data pair whose signs do not match, the second buffer preferentially holding the second data pair than the first data pair;
executing a multiply-accumulate operation of data pairs sequentially output from the first buffer and data pairs sequentially output from the second buffer in parallel;
adding an operation result of the multiplier-accumulate operation of the data pairs output from the first buffer and an operation result of the multiplier-accumulate operation of the data pairs output from the second buffer; and
setting an output value to 0 in a case where the number of the first data pairs held in the first buffer and the second buffer is smaller than the number of the second data pairs held in the first buffer and the second buffer, and a result of the addition when the multiply-accumulate operation of the first data pair is completed is 0 or less.
